(19) United States
(12) Patent Application Publication
(10) Pub. No.: US 2012/0087238 A1
(43) Pub. Date: Apr. 12, 2012

(54) TERMINAL DEVICE AND RETRANSMISSION CONTROL METHOD

(75) Inventors: Seigo Nakao, Kanagawa (JP); Daichi Imamura, Kanagawa (JP)

(73) Assignee: Panasonic Corporation, Osaka (JP)

(21) Appl. No.: 13/376,987

(22) PCT Filed: Jun. 18, 2010
(86) PCT No.: PCT/JP2010/004100

§ 371 Date: Dec. 8, 2011

(30) Foreign Application Priority Data
Jun. 19, 2009 (JP) 2009-146593

(51) Int. Cl. H04W 40/00; H04L 12/26

(52) U.S. Cl. 370/225

(57) ABSTRACT

Provided are a terminal device and a retransmission control method which enable the reduction of the overhead of an uplink control channel when ARQ is applied in communication using an uplink unit band and a plurality of downlink unit bands associated with the uplink unit band. In a terminal (200), when the number of downlink unit bands included in a unit band group is three, a control unit (209) transmits a bundle response signal using a resource in a basic region of an uplink control channel associated with a downlink control channel in a basic unit band when downlink assignment control information transmitted in the basic unit band is received and no error is detected in downlink data transmitted through a downlink data channel indicated by the downlink assignment control information, and the control unit transmits the bundle response signal using a resource in an additional region of the uplink control channel, which is signaled in advance by a base station (100), when the reception of the downlink data transmitted in the basic unit band has not succeeded.

### TECHNICAL FIELD

The present invention relates to a terminal apparatus and retransmission control method.

### BACKGROUND ART

3GPP LTE adopts OFDMA (Orthogonal Frequency Division Multiple Access) as a downlink communication scheme. In a radio communication system to which 3GPP LTE is applied, a base station transmits a synchronization signal (Synchronization Channel: SCH) and broadcast signal (Broadcast Channel: BCH) using predetermined communication resources. A terminal secures synchronization with the base station by catching an SCH first. After that, the terminal acquires parameters specific to the base station (e.g. frequency bandwidth) by reading BCH information (see Non-Patent Literatures 1, 2 and 3).

Furthermore, after completing the acquisition of parameters specific to the base station, the terminal makes a connection request to the base station to thereby establish communication with the base station. The base station transmits control information to the terminal with which communication is established via a PDCCH (Physical Downlink Control CHannel) as required.

The terminal then makes a “blind decision” on each of a plurality of pieces of control information included in the received PDCCH signal. That is, the control information includes a CRC (Cyclic Redundancy Check) portion and this CRC portion is masked with a terminal ID of the transmission target terminal in the base station. Therefore, the terminal cannot decide whether or not the control information is directed to the terminal until the CRC portion of the received control information is demasked with the terminal ID of the terminal. When the demasking result shows that the CRC calculation is OK in the blind decision, the control information is decided to be directed to the terminal.

Furthermore, in 3GPP LTE, ARQ (Automatic Repeat Request) is applied to downlink data from a base station to a terminal. That is, the terminal feeds back a response signal indicating the error detection result of the downlink data to the base station. The terminal performs a CRC on the downlink data and feeds back ACK (Acknowledgment) when CRC=OK (no error) and NACK (Negative Acknowledgment) when CRC=NG (error present) as a response signal to the base station. An uplink control channel such as PUCCH (Physical Uplink Control Channel) is used for feedback of this response signal (that is, ACK/NACK signal).

Here, the control information transmitted from the base station includes resource assignment information including resource information or the like assigned by the base station to the terminal. The aforementioned PDCCH is used for transmission of this control information. This PDCCH is made up of one or a plurality of L1/L2 CCHs (L1/L2 Control Channels). Each L1/L2 CCH is made up of one or a plurality of CCEs (Control Channel Elements). That is, a CCE is a base unit when control information is mapped to a PDCCH. Furthermore, when one L1/L2 CCH is made up of a plurality of CCEs, a plurality of continuous CCEs are assigned to the L1/L2 CCH. The base station assigns an L1/L2 CCH to the resource assignment target terminal according to the number of CCEs necessary to report control information for the resource assignment target terminal. The base station then transmits control information mapped to physical resources corresponding to the CCEs of the L1/L2 CCH.

Here, each CCE has a one-to-one correspondence with a component resource of the PUCCH. Therefore, the terminal that has received the L1/L2 CCH identifies component resources of the PUCCH corresponding to CCEs making up the L1/L2 CCH and transmits a response signal to the base station using the resources. However, when a plurality of CCEs where there are continuous L1/L2 CCHs are occupied, the terminal transmits a response signal to the base station using one of the plurality of PUCCH component resources (e.g. PUCCH component resources corresponding to a CCE having the smallest index) corresponding to the plurality of respective CCEs. This allows downlink communication resources to be used efficiently.

As shown in FIG. 1, a plurality of response signals transmitted from a plurality of terminals are spread by a ZAC (Zero Auto-correlation) sequence having a Zero Auto-correlation characteristic, Walsh sequence and DFT (Discrete Fourier Transform) sequence on the time axis and code-multiplexed within the PUCCH. In FIG. 1, (W₀, W₁, W₂, W₃) represents a Walsh sequence having a sequence length of 4 and (F₀, F₁, F₂) represents a DFT sequence having a sequence length of 3. As shown in FIG. 1, in the terminal, a response signal such as ACK or NACK is primary-spread by a ZAC sequence (sequence length 12) into a frequency component corresponding to 1 SC-FDMA symbol on the frequency axis first. Next, the primary-spread response signal and the ZAC sequence as a reference signal are secondary-spread in association with a Walsh sequence (sequence length 4: W₀ to W₃) and DFT sequence (sequence length 3: F₀ to F₃) respectively. Furthermore, the secondary-spread signal is further transformed into a signal having a sequence length of 12 on the time axis through IFFT (Inverse Fast Fourier Transform). A CP is added to each signal after the IFFT and a one-slot signal made up of seven SC-FDMA symbols is thereby formed.

Response signals transmitted from different terminals are spread using a ZAC sequence corresponding to different cyclic shift indices or orthogonal code sequences corresponding to different sequence numbers (Orthogonal cover Index: OC index). The orthogonal code sequence is a combination of a Walsh sequence and a DFT sequence. Furthermore, the orthogonal code sequence may be referred to as a “block-wise spreading code.” Therefore, the base station can demultiplex a plurality of code-multiplexed response signals using conventional despreading and correlation processing (see Non-Patent Literature 4).

However, since each terminal makes a blind decision on a downlink assignment control signal directed to the terminal in each subframe, the terminal side does not necessarily succeed in receiving the downlink assignment control signal. When the terminal fails to receive the downlink assignment control signal directed to the terminal in a certain downlink unit band, the terminal cannot even know whether or not there is downlink data directed to the terminal in the downlink unit baud. Therefore, when failing to receive the downlink assignment control signal in a certain downlink unit band, the terminal cannot even generate a response signal for the downlink data in the downlink unit band. This error case is defined as a DTX of response signal (DTX (Discontinuous transmission) of ACK/NACK signals) in the sense that transmission of the response signal is not performed on the terminal side.

Furthermore, standardization of 3GPP LTE-advanced which realizes faster communication than 3GPP LTE has started. A 3GPP LTE-advanced system (hereinafter, may also be referred to as “LTE-A system”) follows the 3GPP LTE system (hereinafter also referred to as “LTE system”). In order to realize a downlink transmission rate of a maximum of 1 Gbps or above, 3GPP LTE-advanced is expected to introduce base stations and terminals capable of communicating at a wideband frequency of 40 MHz or above.

In an LTE-A system, to realize communication at an ultra-high transmission rate several times as fast as the transmission rate in an LTE system and backward compatibility with the LTE system simultaneously, a band for the LTE-A system is divided into “unit bands” of 20 MHz or less, which is a support bandwidth for the LTE system. That is, the “unit baud” is a band having a width of maximum 20 MHz and defined as a base unit of a communication band. Furthermore, a “unit band” in a downlink (hereinafter referred to as “downlink unit band”) may be defined as a band divided by downlink frequency band information in a BCH broadcast from the base station or by a spreading width when the downlink control channel (PDCCH) is spread and arranged in the frequency domain. On the other hand, a “unit band” in an uplink (hereinafter referred to as “uplink unit band”) may be defined as a band divided by uplink frequency band information in a BCH broadcast from the base station or as a base unit of a communication band of 20 MHz or less including a PUSCH (Physical Uplink Shared CHannel) region near the center and PUCCHs for LTE at both ends. Furthermore, in 3GPP LTE-Advanced, the “unit baud” may also be expressed as “component carrier(s)” in English.

The LTE-A system supports communication using a baud that bundles several unit bands, so-called “carrier aggregation.” Since throughput requirements for an uplink are generally different from throughput requirements for a downlink, in the LTE-A system, studies are being carried out on carrier aggregation using different numbers of unit bands set for an arbitrary LTE-A system compatible terminal (hereinafter referred to as “LTE-A terminal”) between the uplink and downlink, so-called “asymmetric carrier aggregation.” Cases are also supported where the number of unit bands is asymmetric between the uplink and downlink and the frequency bandwidth differs from one unit band to another.

FIG. 2 is a diagram illustrating asymmetric carrier aggregation and its control sequence applied to individual terminals. FIG. 2 shows an example where the bandwidth and the number of unit bands are symmetric between the uplink and downlink of a base station.

In FIG. 2, a setting (configuration) is made for terminal 1 such that carrier aggregation is performed using two downlink unit bands and one uplink unit band on the left side, whereas a setting is made for terminal 2 such that although the two same downlink unit bands as those in terminal 1 are used, the uplink unit band on the right side is used for uplink communication.

Focusing attention on terminal 1, signals are transmitted/received between an LTE-A base station and LTE-A terminal making up an LTE-A system according to the sequence diagram shown in FIG. 2A. As shown in FIG. 2A, (1) terminal 1 establishes synchronization with the downlink unit band on the left side at a start of communication with the base station and reads information of the uplink unit band which forms a pair with the downlink unit band on the left side from a broadcast signal called “SIB2 (System Information Block Type 2).” (2) Using this uplink unit band, terminal 1 starts communication with the base station by transmitting, for example, a connection request to the base station. (3) Upon deciding that a plurality of downlink unit bands need to be assigned to the terminal, the base station instructs the terminal to add a downlink unit band. In this case, however, the number of uplink unit bands does not increase and terminal 1 which is an individual terminal starts asymmetric carrier aggregation.

Furthermore, in LTE-A to which the aforementioned carrier aggregation is applied, the terminal may receive a plurality of pieces of downlink data in a plurality of downlink unit bands at a time. In LTE-A, studies are being carried out on channel selection (also referred to as “multiplexing”) as one of transmission methods for a plurality of response signals for the plurality of pieces of downlink data. In channel selection, not only symbols used for a response signal but also resources to which the response signal is mapped are changed according to a pattern of error detection results regarding the plurality of pieces of downlink data. That is, channel selection is a technique that changes not only phase points (that is, constellation points) of a response signal but also resources used to transmit the response signal based on whether each of response signals for a plurality of pieces of downlink data received in a plurality of downlink unit bands as shown in FIG. 3 is ACK or NACK (see Non-Patent Literatures 5 and 6).

Here, ARQ control by channel selection when the above-described asymmetric carrier aggregation is applied to a terminal will be described using FIG. 3.

When, for example, a unit band group made up of downlink unit bands 1 and 2, and uplink unit band 1 (which may be expressed as “component carrier set” in English) is set for terminal 1 as shown in FIG. 3, downlink resource assignment information is transmitted from the base station to terminal 1 via respective PDCCHs of downlink unit bands 1 and 2 and then downlink data is transmitted using resources corresponding to the downlink resource assignment information.

When the terminal succeeds in receiving downlink data in unit band 1 and fails to receive downlink data in unit band 2 (that is, when the response signal of unit band 1 is ACK and the response signal of unit band 2 is NACK), the response signal is mapped to PUCCH resources included in PUCCH region 1 and a first constellation point (e.g. constellation point (1,0)) is used as a constellation point of the response signal. On the other hand, when the terminal succeeds in receiving downlink data in unit band 1 and also succeeds in receiving downlink data in unit band 2, the response signal is mapped to PUCCH resources included in PUCCH region 2 and the first constellation point is used. That is, when there are two downlink unit bands, since there are four error detection result patterns, the four patterns can be represented by combinations of two resources and two types of constellation point. Therefore, BPSK having two constellation points is used as the modulation scheme.

### CITATION LIST

### Non-Patent Literature

NPL 1
3GPP TS 36.211 V8.6.0, “Physical Channels and Modulation (Release 8),” March 2009
NPL 2
3GPP TS 36.212 V8.6.0, “Multiplexing and channel coding (Release 8),” March 2009
NPL 3
3GPP TS 36.213 V8.6.0, “Physical layer procedures (Release 8),” March 2009
NPL 4
Seigo Nakao et al. “Performance enhancement of E-UTRA uplink control channel in fast fading environments”, Proceeding of VTC2009 spring, April, 2009
NPL 5
ZTE, 3GPP RAN1 meeting #57, R1-091702, “Uplink Control Channel Design for LTE-Advanced,” May 2009
NPL 6
Panasonic, 3GPP RAN1 meeting #57, R1-091744, “UL ACK/NACK transmission on PUCCH for carrier aggregation,” May 2009

### SUMMARY OF INVENTION

### Technical Problem

However, since an arbitrary terminal transmits a response signal using one of a plurality of PUCCH resources in the aforementioned channel selection, the base station side must secure a plurality of PUCCH resources for the arbitrary terminal.

In an LTE system, since, for example, downlink unit band 1 in FIG. 3 is associated with uplink unit band 1 to form a band pair and downlink unit band 2 is associated with uplink unit band 2 to form a band pair, PUCCH corresponding to downlink unit band 2 needs to be provided for only uplink unit band 2. On the other hand, in LTE-A, when asymmetric carrier aggregation is individually set (configured) for terminals, as shown in FIG. 3, uplink unit band 1 also needs to secure PUCCH resources for a response signal for downlink unit band 2 caused by the association of unit bands specific to the LTE-A terminal such as downlink unit band 2 and uplink unit band 1. That is, the uplink control channel (PUCCH) of uplink unit band 1 needs to be provided with an additional region (PUCCH region 2) in addition to the basic region (PUCCH region 1).

This means that when channel selection is applied as a response signal transmission method in the LTE-A system, the PUCCH overhead drastically increases compared to the LTE system. This additional overhead for the LTE system increases as the asymmetry between downlink unit bands and uplink unit bands of a terminal increases as shown in FIG. 4.

To reduce additional overhead for this LTE system, the M-ary modulation value may be increased. That is, as shown, for example, in FIG. 5, the number of PUCCH resources (that is, the number of PUCCH regions) to be assigned may be reduced by increasing information that can be reported by one resource using QPSK modulation. However, as described above, since PUCCH resources in each PUCCH region are reported in association with a CCE number occupied by downlink assignment control information, when the terminal fails to receive downlink assignment control information in a certain downlink unit band, the terminal side cannot recognize which PUCCH resources in the PUCCH region associated with the unit band should be used.

These problems will be described in further detail using FIG. 5.

Whether or not the base station should retransmit downlink data is determined by whether or not the terminal reports ACK for the downlink data. That is, the base station retransmits the downlink data not only when the terminal succeeds in receiving downlink assignment control information and fails to decode downlink data but also when the terminal fails to receive the downlink assignment control information itself. However, whether or not the terminal fails to receive downlink assignment control information in a certain downlink unit band is detected based on a DAI (Downlink Assignment Indicator) reported by downlink assignment control information of each downlink unit band. This DAI is information indicating in which downlink unit band downlink resources are assigned to the terminal. The terminal treats a case of failing to receive the downlink assignment control information itself the same as a case of failing to decode downlink data and feeds back a response signal to the base station.

In FIG. 5A, downlink data is transmitted to the terminal using two downlink unit bands. When there are two downlink unit bands, the terminal side has two states for respective pieces of downlink data; success in reception (ACK) or failure in reception (that is, NACK or DTX), and therefore there are 2̂2 (square of 2), that is, four patterns of error detection results. Therefore, if QPSK is used to transmit a response signal, channel selection may be performed using only PUCCH resources in PUCCH region 1 without the necessity for having additional PUCCH resources for the LTE system as shown in FIG. 5A.

However, when the terminal side actually fails to receive downlink assignment control information transmitted in downlink unit band 1, the terminal cannot decide which PUCCH resources in PUCCH region 1 should be used. Therefore, reporting the failure to receive downlink assignment control information transmitted in downlink unit band 1 requires alternate means such as using PUCCH resources in PUCCH region 2. For this reason, also when downlink data is transmitted to the terminal using two downlink unit bands, it is necessary to assign PUCCH resources of both PUCCH region 1 and PUCCH region 2 to the terminal.

Similarly, in FIG. 5B, downlink data is transmitted to the terminal using three downlink unit bands. When there are three downlink unit bands, there are two states; success in reception (ACK) or failure in reception (that is, NACK or DTX) for respective pieces of downlink data on the terminal side, and therefore there are 2̂3 (cube of 2), that is, eight patterns of error detection results. Therefore, if QPSK is used to transmit a response signal, channel selection may be performed using only PUCCH resources in PUCCH region 1 and PUCCH region 2 by securing only one additional PUCCH region for the LTE system as shown in FIG. 5B.

However, when the terminal side actually fails to receive downlink assignment control information transmitted in downlink unit band 1, the terminal cannot decide which PUCCH resources in PUCCH region 1 should be used. Furthermore, when the terminal side fails to receive downlink assignment control information transmitted in downlink unit band 2, the terminal cannot decide which PUCCH resources in PUCCH region 2 should be used. Therefore, reporting the failure in reception of downlink assignment control information transmitted in downlink unit bands 1 and 2 requires alternate means such as using PUCCH resources in PUCCH region 3. For this reason, also when downlink data is transmitted to the terminal using three downlink unit bands, PUCCH resources in the three regions of PUCCH regions 1, 2 and 3 need to be assigned to the terminal.

As described above, it is not possible to reduce the aforementioned additional overhead by simply increasing the M-ary modulation value as the number of patterns of error detection results increases.

It is an object of the present invention to provide a terminal apparatus and a retransmission control method capable of reducing overhead of an uplink control channel for when ARQ is applied to communication using an uplink unit band and a plurality of downlink unit bands associated with the uplink unit band.

### Solution to Problem

A terminal apparatus according to the present invention is a terminal apparatus that communicates with a base station using a unit band group made up of a plurality of downlink unit bands and an uplink unit band and transmits one bundled response signal through an uplink control channel of the uplink unit band based on error detection results of a plurality of pieces of downlink data arranged in the plurality of downlink unit bands, including a control information receiving section that receives downlink assignment control information transmitted through downlink control channels of the plurality of downlink unit bands, a downlink data receiving section that receives downlink data transmitted through a downlink data channel indicated by the downlink assignment control information, an error detection section that detects a reception error of the received downlink data and a response control section that transmits the bundled response signal using one of a basic region and an additional region of the uplink control channel based on the error detection result obtained in the error detection section and success/failure in reception of the downlink assignment control information, wherein when the number of downlink unit bands included in the unit band group is 3, if the response control section receives downlink assignment control information transmitted in a base unit band which is a downlink unit band for transmitting a broadcast channel signal including information on the uplink unit band and detects no error in the downlink data transmitted through the downlink data channel indicated by the downlink assignment control information, the response control section transmits the bundled response signal using resources in the basic region associated with the downlink control channel of the base unit band and, when failing to receive downlink assignment control information transmitted in the base unit band or when receiving downlink assignment control information transmitted in the base unit band and detecting an error in the downlink data transmitted through the downlink data channel indicated by the downlink assignment control information, the response control section transmits the bundled response signal using resources in the additional region.

A retransmission control method according to the present invention includes a control information receiving step of receiving downlink assignment control information transmitted through downlink control channels of a plurality of downlink unit bands included in a unit band group, a downlink data receiving step of receiving downlink data transmitted through a downlink data channel indicated by the downlink assignment control information, an error detection step of detecting a reception error of the received downlink data, and a response control step of transmitting one bundled response signal based on error detection results of a plurality of pieces of downlink data arranged in the plurality of downlink unit bands using one of a basic region and an additional region of an uplink control channel in an uplink unit band included in the unit band group based on the error detection results obtained in the error detection section and success/failure in reception of the downlink assignment control information, wherein in the response control step, when the number of downlink unit bands included in the unit band group is 3, downlink assignment control information transmitted in a base unit band which is a downlink unit band for transmitting a broadcast channel signal including information on the uplink unit band is received and when no error is detected in the downlink data transmitted in the downlink data channel indicated by the downlink assignment control information, the bundled response signal is transmitted using resources in the basic region associated with the downlink control channel of the base unit band, and when reception of the downlink assignment control information transmitted in the base unit band fails or the downlink assignment control information transmitted in the base unit band is received and an error is detected in the downlink data transmitted through the downlink data channel indicated by the downlink assignment control information, the bundled response signal is transmitted using resources in the additional region.

### Advantageous Effects of Invention

The present invention can provide a terminal apparatus and retransmission control method for when ARQ is applied to communication using an uplink unit band and a plurality of downlink unit bands associated with the uplink unit band, capable of reducing overhead of an uplink control channel.

### BRIEF DESCRIPTION OF DRAWINGS

FIG. 1 is a diagram illustrating a method of spreading a response signal and reference signal;

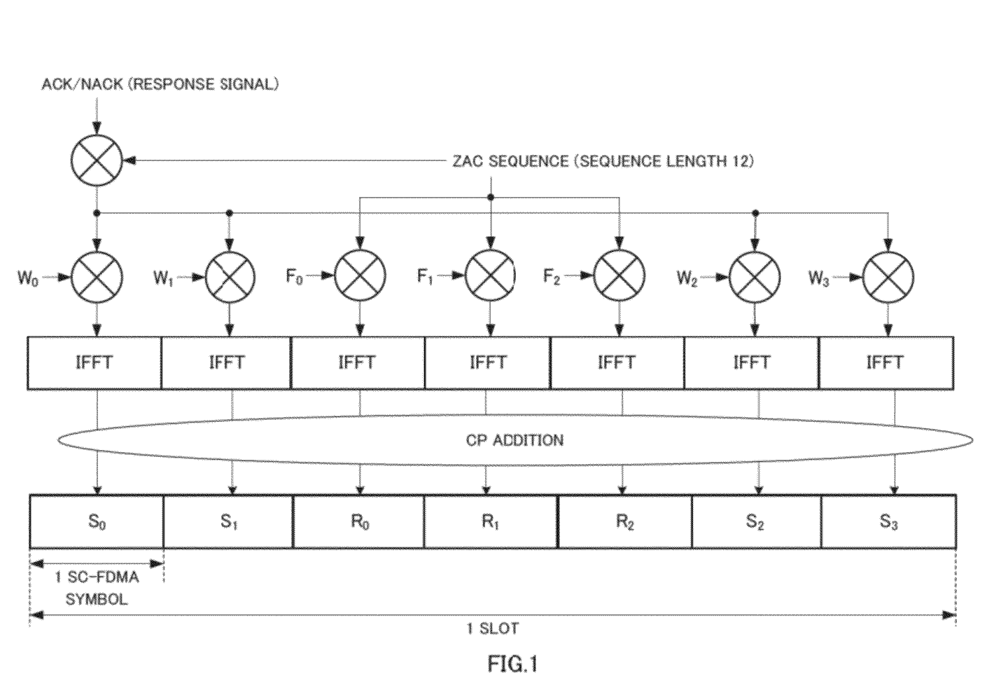

FIG. 2 is a diagram illustrating asymmetric carrier aggregation applied to individual terminals and a control sequence thereof;

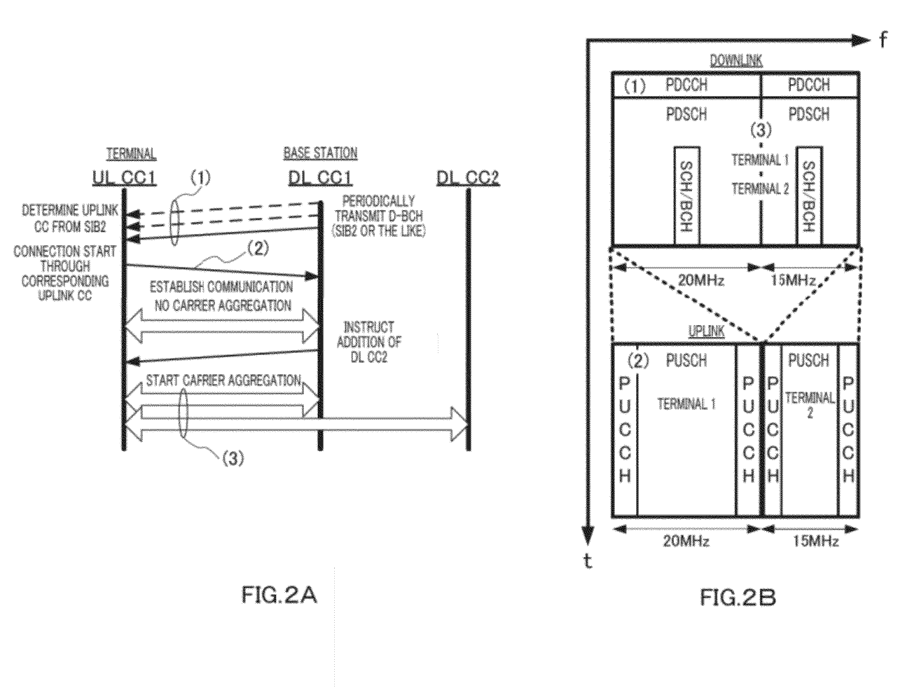

FIG. 3 is a diagram illustrating ARQ control when carrier aggregation is applied to a terminal;

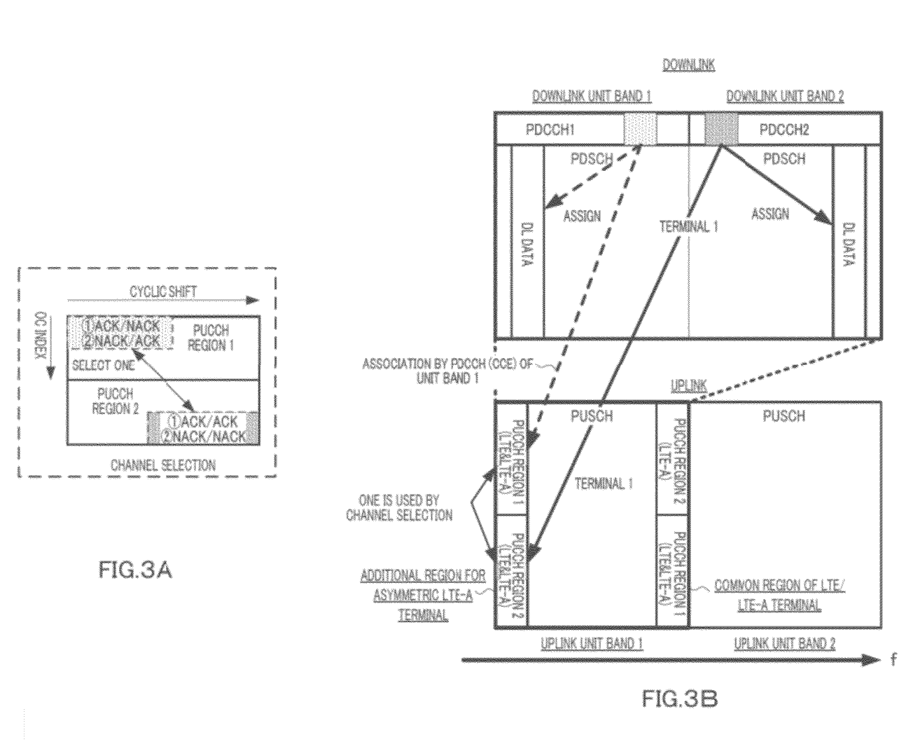

FIG. 4 is a diagram illustrating ARQ control when carrier aggregation is applied to a terminal;

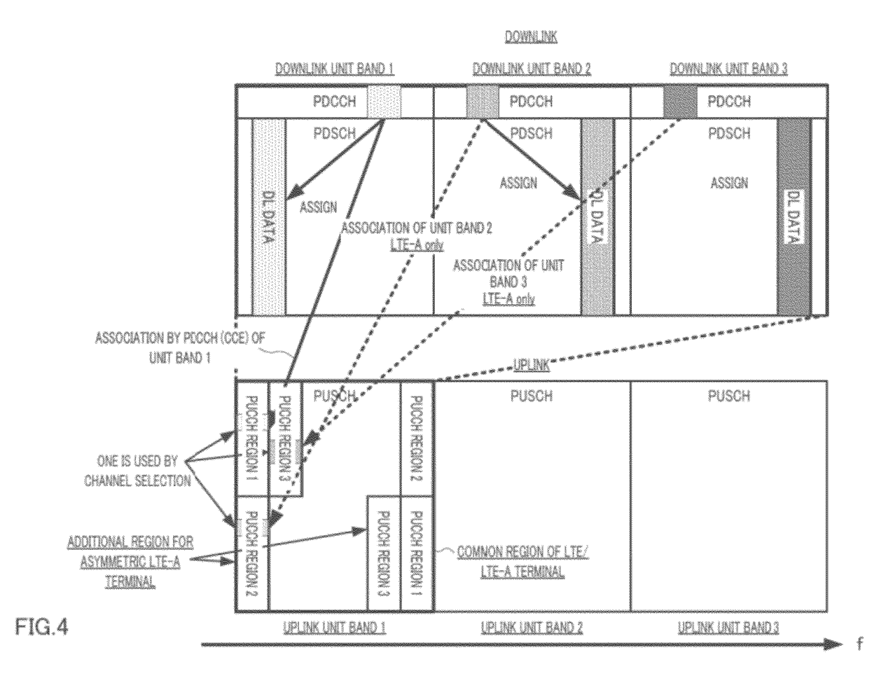

FIG. 5 is a diagram illustrating ARQ control when carrier aggregation is applied to a terminal;

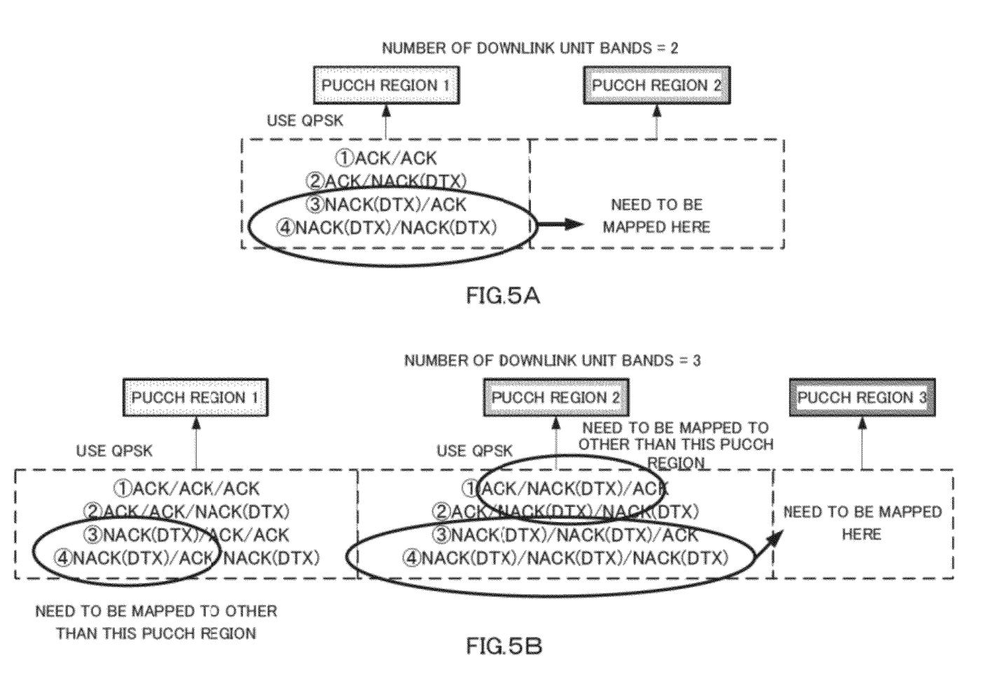

FIG. 6 is a block diagram showing a configuration of a base station according to Embodiment 1 of the present invention;

FIG. 7 is a block diagram showing a configuration of a terminal according to Embodiment 1 of the present invention;

FIG. 8 is a diagram illustrating operations of the base station and terminal; and

FIG. 9 is a diagram illustrating operations of a base station and terminal according to Embodiment 2 of the present invention.

### DESCRIPTION OF EMBODIMENTS

Hereinafter, embodiments of the present invention will be described in detail with reference to the accompanying drawings. The same components among different embodiments will be assigned the same reference numerals and overlapping descriptions thereof will be omitted.

### Embodiment 1

### Overview of Communication System

A communication system including base station 100 and terminal 200, which will be described later, performs communication using an uplink unit band and three downlink unit bands associated with the uplink unit band, that is, communication using asymmetric carrier aggregation specific to terminal 200. Furthermore, this communication system also includes terminals that have no capability of performing communication using carrier aggregation unlike terminal 200 and perform communication using one downlink unit band and one uplink unit band associated therewith (that is, communication without using carrier aggregation).

Therefore, base station 100 is configured to be able to support both communication using asymmetric carrier aggregation and communication without using carrier aggregation.

Furthermore, communication without using carrier aggregation can also be performed between base station 100 and terminal 200 depending on resource assignment to terminal 200 by base station 100.

Furthermore, this communication system performs conventional ARQ when performing communication without using carrier aggregation on one hand, and adopts channel selection in ARQ when performing communication using carrier aggregation on the other. That is, this communication system is, for example, an LTE-A system, base station 100 is, for example, an LTE-A base station and terminal 200 is, for example, an LTE-A terminal. Furthermore, the terminal having no capability of performing communication using carrier aggregation is, for example, an LTE terminal.

Descriptions will be given below assuming the following matters as premises. That is, asymmetric carrier aggregation specific to terminal 200 is configured beforehand between base station 100 and terminal 200 and information of downlink unit bands and uplink unit bands to be used by terminal 200 is shared between base station 100 and terminal 200. Furthermore, the downlink unit band set (configured) for arbitrary terminal 200 by base station 100 for transmitting BCH for broadcasting information on an uplink unit band making up a unit band group reported (signaled) to terminal 200 beforehand is a “base unit band” for terminal 200. The information on this base unit band is “base unit band information.” Therefore, arbitrary terminal 200 can recognize the base unit band information by reading BCH information in each downlink unit band.

[Configuration of Base Station]

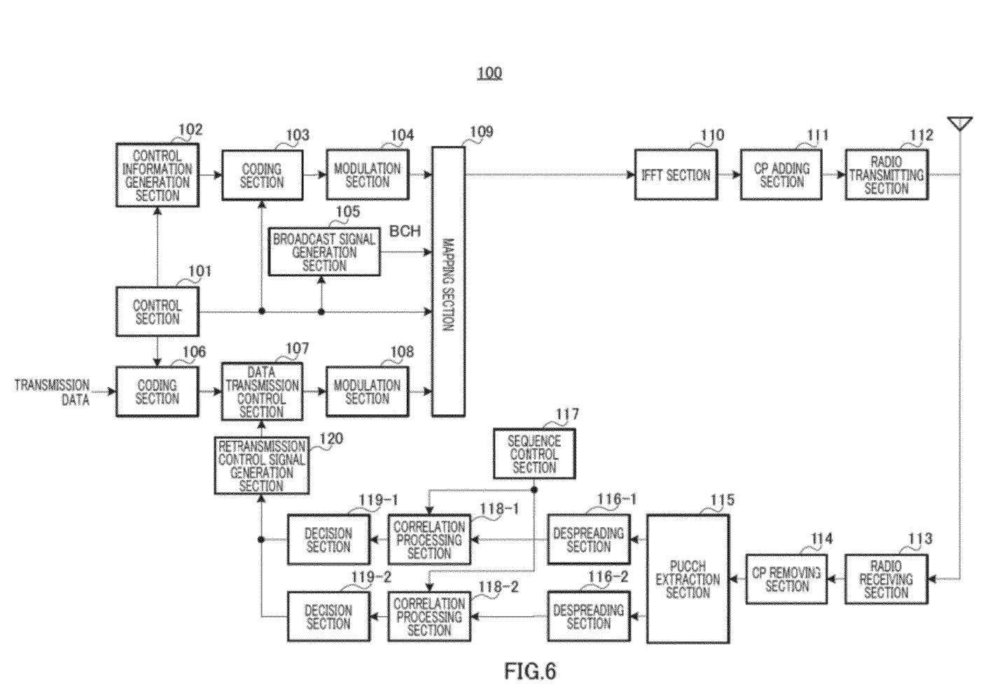

FIG. 6 is a block diagram showing a configuration of base station 100 according to Embodiment 1 of the present invention. In FIG. 6, base station 100 includes control section 101, control information generation section 102, coding section 103, modulation section 104, broadcast signal generation section 105, coding section 106, data transmission control section 107, modulation section 108, mapping section 109, IFFT section 110, CP adding section 111, radio transmitting section 112, radio receiving section 113, CP removing section 114, PUCCH extraction section 115, despreading section 116, sequence control section 117, correlation processing section 118, decision section 119 and retransmission control signal generation section 120.

Control section 101 assigns, to resource assignment target terminal 200, downlink resources to transmit control information (that is, downlink control information assignment resources), downlink resources to transmit downlink data included in the control information (that is, downlink data assignment resources). Such resources are assigned in downlink unit bands included in a unit band group set in resource assignment target terminal 200. Furthermore, the downlink control information assignment resources are selected from among resources corresponding to a downlink control channel (PDCCH) in each downlink unit band. Furthermore, the downlink data assignment resources are selected from among resources corresponding to a downlink data channel (PDSCH) in each downlink unit band. Furthermore, when there are a plurality of resource assignment target terminals 200, control section 101 assigns different resources to respective resource assignment target terminals 200.

The downlink control information assignment resources are equivalent to above-described L1/L2 CCHs. That is, each of the downlink control information assignment resources is made up of one or a plurality of CCEs. Furthermore, each CCE in the base unit band is associated with a component resource in an uplink control channel region (PUCCH region) in an uplink unit band in the unit band group in a one-to-one correspondence.

Furthermore, control section 101 determines a coding rate used to transmit control information to resource assignment target terminal 200. Since the amount of data of the control information differs according to this coding rate, control section 101 assigns downlink control information assignment resources having a number of CCEs to which control information corresponding to this amount of data is mapped.

Furthermore, control section 101 generates a DAI (Downlink Assignment Indicator) which is information indicating which downlink unit band is used to assign downlink resources to resource assignment target terminal 200.

Control section 101 then outputs information on the downlink data assignment resources and a DAI to control information generation section 102. Furthermore, control section 101 outputs information on a coding rate to coding section 103. Furthermore, control section 101 determines a coding rate of transmission data (that is, downlink data) and outputs the coding rate to coding section 106. Furthermore, control section 101 outputs information on downlink data assignment resources and downlink control information assignment resources to mapping section 109. However, control section 101 performs control so as to map downlink data and downlink control information for the downlink data to the same downlink unit band.

Furthermore, control section 101 outputs a control signal to generate a broadcast channel signal (BCH) to be transmitted to broadcast signal generation section 105.

Control information generation section 102 generates information on downlink data assignment resources and control information including a DAI and outputs the information to coding section 103. The control information is generated for each downlink unit band. Furthermore, when there are a plurality of resource assignment target terminals 200, the control information includes a terminal ID of a destination terminal to distinguish between resource assignment target terminals 200. For example, the control information includes a CRC bit masked with a terminal ID of the destination terminal. This control information may be called “downlink assignment control information.” Furthermore, the DAI is included in all control information directed to resource assignment target terminals 200.

Coding section 103 codes control information according to the coding rate received from control section 101 and outputs the coded control information to modulation section 104.

Modulation section 104 modulates the coded control information and outputs the modulated signal obtained to mapping section 109.

Broadcast signal generation section 105 generates a broadcast signal (BCH) for each downlink unit band according to the information and control signal received from control section 101 and outputs the broadcast signal to mapping section 109.

Coding section 106 receives transmission data per destination terminal 200 (that is, downlink data) and coding rate information from control section 101 as input, codes transmission data and outputs the coded transmission data to data transmission control section 107. However, when a plurality of downlink unit bands are assigned to destination terminal 200, transmission data transmitted in each downlink unit band is coded and the coded transmission data is outputted to data transmission control section 107.

Upon initial transmission, data transmission control section 107 stores the coded transmission data and also outputs the coded transmission data to modulation section 108. The coded transmission data is stored for each destination terminal 200. Furthermore, transmission data for one destination terminal 200 is stored for each downlink unit band transmitted. This enables not only retransmission control over the entire data transmitted to destination terminal 200 but also retransmission control over each downlink unit band.

Furthermore, upon receiving NACK or DTX for downlink data transmitted in a certain downlink unit band from retransmission control signal generation section 120, data transmission control section 107 outputs the stored data corresponding to this downlink unit band to modulation section 108. Upon receiving ACK for downlink data transmitted in a certain downlink unit band from retransmission control signal generation section 120, data transmission control section 107 deletes the stored data corresponding to this downlink unit band.

Modulation section 108 modulates the coded transmission data received from data transmission control section 107 and outputs the modulated signal to mapping section 109.

Mapping section 109 maps the modulated signal of the control information received from modulation section 104 to resources indicated by the downlink control information assignment resources and outputs the mapping result to IFFT section 110.

Furthermore, mapping section 109 maps the modulated signal of the transmission data received from modulation section 108 to resources indicated by the downlink data assignment resources received from control section 101 and outputs the mapping result to IFFT section 110.

Mapping section 109 maps broadcast information to predetermined time/frequency resources and outputs the mapped broadcast information to IFFT section 110.

The control information, transmission data or broadcast signal mapped by mapping section 109 to a plurality of subcarriers in a plurality of downlink unit bands is transformed by IFFT section 110 from a frequency domain signal into a time domain signal, transformed into an OFDM signal with a CP added by CP adding section 111, subjected to transmission processing such as D/A conversion, amplification and up-conversion in radio transmitting section 112 and transmitted to terminal 200 via an antenna.

Radio receiving section 113 receives a response signal or reference signal transmitted from terminal 200 via the antenna and performs reception processing such as down-conversion and A/D conversion on the response signal or reference signal.

CP removing section 114 removes a CP added to the response signal or reference signal after the reception processing.

PUCCH extraction section 115 extracts an uplink control channel signal included in the received signal for each PUCCH region and distributes the extracted signals. This uplink control channel signal may include a response signal and a reference signal transmitted from terminal 200.

Despreading sections 116-1 and 2, correlation processing sections 118-1 and 2 and decision sections 119-1 and 2 perform processing on the uplink control channel signal extracted in PUCCH regions 1 and 2. Base station 100 is provided with processing systems of despreading sections 116, correlation processing sections 118 and decision sections 119 corresponding to respective PUCCH regions 1 and 2 used by base station 100. This PUCCH region 1 is a basic region of an uplink control channel, which will be described later, and PUCCH region 2 is an additional region of the uplink control channel.

To be more specific, despreading section 116 despreads a signal corresponding to a response signal with an orthogonal code sequence for terminal 200 to use for secondary-spreading in the respective PUCCH regions and outputs the despread signal to correlation processing section 118. Furthermore, despreading section 116 despreads a signal corresponding to the reference signal with an orthogonal code sequence for terminal 200 to use to spread the reference signal in the respective uplink unit bands and outputs the despread signal to correlation processing section 118.

Sequence control section 117 generates a ZAC sequence that may be possibly used to spread a response signal and reference signal transmitted from terminal 200. Furthermore, sequence control section 117 identifies a correlation window in which signal components from terminal 200 should be included in PUCCH regions 1 and 2 respectively based on code resources (e.g. amount of cyclic shift) that may be possibly used by terminal 200. Sequence control section 117 then outputs the information indicating the identified correlation window and the generated ZAC sequence to correlation processing section 118.

Correlation processing section 118 calculates a correlation value between the signal inputted from despreading section 116 and the ZAC sequence that may be possibly used for primary spreading in terminal 200 using information indicating the correlation window inputted from sequence control section 117 and the ZAC sequence and outputs the correlation value to decision section 119.

Decision section 119 decides whether the response signal transmitted from the terminal indicates ACK or NACK (or DTX) with respect to the data transmitted in their respective downlink unit bands based on the correlation value inputted from correlation processing section 118. That is, decision section 119 decides, when the magnitude of the correlation value inputted from correlation processing section 118 is a certain threshold or below, that terminal 200 is transmitting neither ACK nor NACK using the resources, and further decides, when the magnitude of the correlation value is the threshold or above, which constellation point the response signal indicates through coherent detection. Decision section 119 then outputs the decision result in each PUCCH region to retransmission control signal generation section 120.

Retransmission control signal generation section 120 decides whether or not to retransmit the data transmitted in each downlink unit band based on the information inputted from decision section 119 and generates a retransmission control signal based on the decision result.

That is, retransmission control signal generation section 120 initially decides in which PUCCH region corresponding to decision sections 119-1 and 2 a maximum correlation value is detected. Next, retransmission control signal generation section 120 individually generates an ACK signal or NACK signal for the data transmitted in each downlink unit band depending on which constellation point the response signal transmitted in the PUCCH region where the maximum correlation value is detected and outputs the ACK signal or NACK signal to data transmission control section 107. However, when all correlation values detected in each PUCCH region are equal to or below a threshold, retransmission control signal generation section 120 decides that no response signal is transmitted from terminal 200, generates DTX for all downlink data and outputs the DTX to data transmission control section 107.

Details of the processing of decision section 119 and retransmission control signal generation section 120 will be described later.

[Configuration of Terminal]

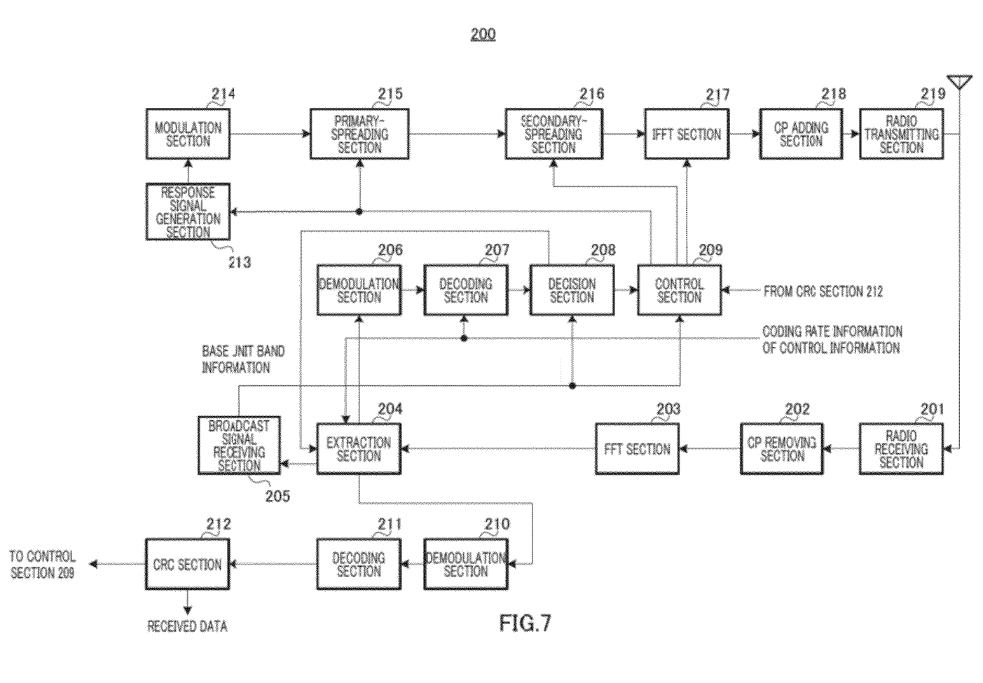

FIG. 7 is a block diagram showing a configuration of terminal 200 according to Embodiment 1 of the present invention. In FIG. 7, terminal 200 includes radio receiving section 201, CP removing section 202, FFT section 203, extraction section 204, broadcast signal receiving section 205, demodulation section 206, decoding section 207, decision section 208, control section 209, demodulation section 210, decoding section 211, CRC section 212, response signal generation section 213, modulation section 214, primary-spreading section 215, secondary-spreading section 216, IFFT section 217, CP adding section 218 and radio transmitting section 219.

Radio receiving section 201 receives an OFDM signal transmitted from base station 100 via an antenna and performs reception processing such as down-conversion, A/D conversion on the received OFDM signal.

CP removing section 202 removes a CP added to the OFDM signal after the reception processing.

FFT section 203 applies FFT to the received OFDM signal, transforms the OFDM signal into a frequency domain signal and outputs the received signal obtained to extraction section 204.

Extraction section 204 extracts a broadcast signal from the received signal received from FFT section 203 and outputs the broadcast signal to broadcast signal receiving section 205. Since resources to which the broadcast signal is mapped are predetermined, extraction section 204 extracts information mapped to the resources. Furthermore, the extracted broadcast signal includes information on the association between each downlink unit band and uplink unit band or the like.

Furthermore, extraction section 204 extracts a downlink control channel signal (PDCCH signal) from the received signal received from FFT section 203 according to the inputted coding rate information. That is, since the number of CCEs making up downlink control information assignment resources changes according to the coding rate, extraction section 204 extracts a downlink control channel signal using a number of CCEs corresponding to the coding rate as an extraction unit. Furthermore, the downlink control channel signal is extracted for each downlink unit band. The extracted downlink control channel signal is outputted to demodulation section 206.

Furthermore, extraction section 204 extracts downlink data from the received signal based on the information on the downlink data assignment resources directed to the terminal received from decision section 208 and outputs the downlink data to demodulation section 210.

Broadcast signal receiving section 205 decodes each broadcast signal included in each downlink unit band and extracts information of an uplink unit band forming a pair with each downlink unit band (that is, information of the uplink unit band reported by SIB2 mapped to each downlink unit band). Furthermore, broadcast signal receiving section 205 recognizes the downlink unit band that forms a pair with the uplink unit band included in the unit band group directed to the terminal as a “base unit band” and outputs the base unit band information to decision section 208 and control section 209.

Demodulation section 206 demodulates the downlink control channel signal received from extraction section 204 and outputs the demodulation result obtained to decoding section 207.

Decoding section 207 decodes the demodulation result received from demodulation section 206 according to the coding rate information inputted and outputs the decoding result obtained to decision section 208.

Decision section 208 makes a blind decision as to whether or not the control information included in the decoding result received from decoding section 207 is control information directed to the terminal. This decision is made based on the unit of the decoding result with respect to the above-described extraction unit. For example, decision section 208 demasks the CRC bit with the terminal ID of the terminal and decides that control information with CRC=OK (no error) is control information directed to the terminal. Decision section 208 then outputs information on the downlink data assignment resources for the terminal included in the control information directed to the terminal to extraction section 204. Furthermore, decision section 208 outputs a DAI included in the control information directed to the terminal to control section 209.

Furthermore, decision section 208 identifies a CCE to which the above-described control information directed to the terminal is mapped on the downlink control channel of the base unit band and outputs identification information of the identified CCE to control section 209.

Control section 209 identifies PUCCH resources (frequency/code) corresponding to the CCE indicated by the CCE identification information received from decision section 208. That is, control section 209 identifies PUCCH resources in the basic region of the uplink control channel (that is, “basic PUCCH resources”) based on the CCE identification information. However, control section 209 stores information on the PUCCH resources in an additional region for channel selection reported from base station 100 to terminal 200 (that is, “additional PUCCH resources”).

Control section 209 determines which of the basic PUCCH resource or additional PUCCH resource is used to transmit a response signal based on the situation of success/failure in reception of the downlink data in each downlink unit band inputted from CRC section 212. That is, control section 209 determines which of the basic PUCCH resource or additional PUCCH resource is used to transmit a response signal according to a pattern of error detection results regarding a plurality of pieces of downlink data. Furthermore, control section 209 determines which constellation point is set for the response signal based on the situation of success/failure in reception of downlink data in each downlink unit band inputted from CRC section 212. That is, control section 209 also controls the modulation scheme (e.g. M-ary modulation value).

Control section 209 then outputs information on the constellation point to be set to response signal generation section 213, outputs the ZAC sequence and amount of cyclic shift corresponding to the PUCCH resources to be used to primary-spreading section 215 and outputs frequency resource information to IFFT section 217. Furthermore, control section 209 outputs an orthogonal code sequence corresponding to the PUCCH resources to be used to secondary-spreading section 216. Details of control over PUCCH resources and constellation points by control section 209 will be described later.

Demodulation section 210 demodulates the downlink data received from extraction section 204 and outputs the demodulated downlink data to decoding section 211.

Decoding section 211 decodes the downlink data received from demodulation section 210 and outputs the decoded downlink data to CRC section 212.

CRC section 212 generates the decoded downlink data received from decoding section 211, performs error detection for each downlink unit band using a CRC and outputs ACK when CRC=OK (no error) and NACK when CRC=NG (error present) to control section 209. Furthermore, when CRC=OK (no error), CRC section 212 outputs the decoded downlink data as the received data.

Response signal generation section 213 generates a response signal and reference signal based on the constellation points of the response signal instructed from control section 209 and outputs the response signal and reference signal to modulation section 214.

Modulation section 214 modulates the response signal inputted from response signal generation section 213 and outputs the modulated response signal to primary-spreading section 215.

Primary-spreading section 215 primary-spreads the response signal and reference signal based on the ZAC sequence and amount of cyclic shift set by control section 209 and outputs the primary-spread response signal and reference signal to secondary-spreading section 216. That is, primary-spreading section 215 primary-spreads the response signal and reference signal according to the instruction from control section 209.

Secondary-spreading section 216 secondary-spreads the response signal and reference signal using an orthogonal code sequence set by control section 209 and outputs the secondary-spread signal to IFFT section 217. That is, secondary-spreading section 216 secondary-spreads the primary-spread response signal and reference signal using an orthogonal code sequence corresponding to the PUCCH resources selected by control section 209 and outputs the spread signal to IFFT section 217.

CP adding section 218 adds the same signal as that of the rear part of the signal after the IFFT at the head of the signal as a CP.

Radio transmitting section 219 performs transmission processing such as D/A conversion, amplification and up-conversion on the signal inputted. Radio transmitting section 219 then transmits the signal to base station 100 from the antenna.

[Operations of Base Station 100 and Terminal 200]

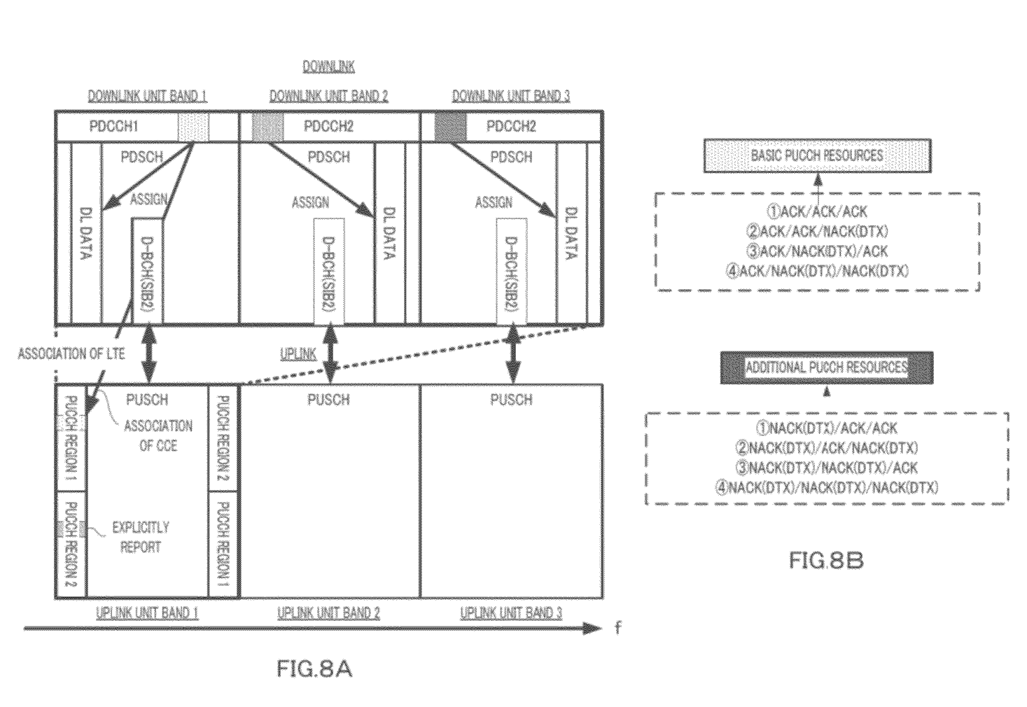

Operations of base station 100 and terminal 200 having the above-described configurations will be described. FIG. 8 is a diagram illustrating operations of base station 100 and terminal 200.

<Reception of Downlink Data by Terminal 200>

In terminal 200, broadcast signal receiving section 205 identifies a downlink unit band to transmit a BCH for broadcasting information on the uplink unit band making up the unit band group reported to terminal 200 as a base unit band.

Furthermore, decision section 208 decides whether or not downlink assignment control information directed to the terminal is included in a downlink control channel of each downlink unit band and outputs the downlink assignment control information directed to the terminal to extraction section 204.

Extraction section 204 extracts downlink data from the received signal based on the downlink assignment control information received from decision section 208.

Thus, terminal 200 can receive downlink data transmitted from base station 100.

Explaining more specifically with reference to FIG. 8, since a BCH for broadcasting information on uplink unit band 1 is transmitted in downlink unit band 1 first, downlink unit band 1 becomes the base unit band of terminal 200.

Furthermore, the downlink assignment control information transmitted in downlink unit band 1 includes information on resources used to transmit downlink data (DL data) transmitted in downlink unit band 1, the downlink assignment control information transmitted in downlink unit band 2 includes information on resources used to transmit downlink data transmitted in downlink unit band 2 and the downlink assignment control information transmitted in downlink unit band 3 includes information on resources used to transmit downlink data transmitted in downlink unit band 3.

Therefore, by receiving the downlink assignment control information transmitted in downlink unit bands 1, 2 and 3, terminal 200 can receive downlink data in downlink unit bands 1, 2 and 3. On the contrary, when the terminal cannot receive downlink assignment control information in a certain downlink unit baud, terminal 200 cannot receive downlink data in the downlink unit band.

Furthermore, terminal 200 can recognize the downlink unit band in which downlink assignment control information is transmitted through a DAI transmitted in each downlink unit band.

<Response by Terminal 200>

CRC section 212 performs error detection on downlink data corresponding to the downlink assignment control information that has been successfully received and outputs the error detection result to control section 209.

Control section 209 then performs transmission control over a response signal based on the error detection result received from CRC section 212 as follows.

That is, as shown in FIG. 8, when the error detection result regarding downlink data transmitted in a base unit band (that is, downlink unit band 1) shows “no error,” control section 209 transmits a response signal using basic PUCCH resources (that is, resources of PUCCH region 1). As described above, the basic PUCCH resources are determined in association with CCEs occupied by downlink assignment control information transmitted to terminal 200 in the base unit band. Furthermore, the basic region including the basic PUCCH resources is a region where a response signal from the LTE terminal and a response signal from the LTE-A terminal coexist.

Control section 209 then switches between constellation points used for response signals according to a pattern of error detection results. That is, when the error detection result regarding the downlink data transmitted in the base unit band is “no error,” there are four patterns of error detection results according to error detection results regarding downlink data transmitted in other than the base unit band (that is, downlink unit bands 2 and 3). Therefore, control section 209 switches between four constellation points (e.g. (I,Q)=(1,0), (−1,0), (0,j), (0,−j)) according to the pattern of error detection results. That is, control section 209 selects QPSK as the modulation scheme.

On the other hand, in “the case of not succeeding in receiving downlink data” transmitted in the base unit band (that is, downlink unit band 1), control section 209 transmits a response signal using additional PUCCH resources (that is, resources of PUCCH region 2). Information of the additional PUCCH resources is shared beforehand between base station 100 and terminal 200 as described above. Furthermore, the additional region including the additional PUCCH resources is the additional PUCCH region reported to the LTE-A terminal.

Control section 209 then switches between constellation points used for response signals according to the pattern of error detection results. That is, in “the case of not succeeding in receiving downlink data” transmitted in the base unit band, there are four patterns of error detection results according to the error detection results regarding downlink data transmitted in other than the base unit band (that is, downlink unit bands 2 and 3). Therefore, control section 209 switches between four constellation points (e.g. (I,Q)=(1,0), (−1,0), (0,j), (0,−j)) according to the pattern of error detection results.

However, the above-described “case of not succeeding in receiving downlink data” includes the following two cases: A first case where the reception of downlink assignment control information corresponding to downlink data succeeds and an error is found in the downlink data decoding result, and a second case where the reception of the downlink assignment control signal itself fails in the downlink unit band in which the presence of downlink data is recognized by means of a DAI included in the downlink assignment control signal that has been successfully received. That is, although the terminal receives downlink assignment control signals in some downlink unit bands and recognizes by means of a DAI included therein that downlink data is assigned in other downlink unit bands, if the terminal fails to receive downlink assignment control signals in the other downlink unit bands and cannot therefore receive downlink data (that is, when DTX occurs in the other downlink unit bands), the terminal treats this case the same as the case with “error present” in the downlink unit band in which the terminal fails to receive the downlink assignment control signal.

As described above, according to the present embodiment, although base station 100 sets (configures) the three downlink unit bands for terminal 200 by applying (element technology 1) to (element technology 3) below, the number of PUCCH resources that should be provided to use channel selection as the uplink response signal transmission scheme can be reduced to 2.

(Element technology 1) The terminal 200 side treats “NACK” indicating that terminal 200 succeeds in receiving a downlink assignment control signal in a certain downlink unit band but fails to decode downlink data the same as “DTX” indicating that terminal 200 fails to receive a downlink assignment control signal in a certain downlink unit band but learns that downlink data is assigned to the downlink unit band by means of a DAI included in the downlink assignment control information received in the other downlink unit band.

(Element technology 2) PUCCH resources to be used by base station 100 as additional PUCCH resources are reported to terminal 200 beforehand. However, basic PUCCH resources are determined in association with CCE numbers occupied by downlink assignment control information in a base unit band.

(Element technology 3) All states of the base unit band including “NACK” or “DTX” are reported by constellation points of a response signal mapped to the additional PUCCH resources.

In short, when the number of downlink unit bands included in the unit band group is 3, control section 209 of terminal 200 receives downlink assignment control information transmitted in the base unit band which is the downlink unit band for transmitting a broadcast channel signal including information on the uplink unit band of the unit band group and transmits, when no error is detected in the downlink data transmitted in the downlink data channel indicated by the downlink assignment control information, a bundled response signal using resources in the basic region of the uplink control channel in the uplink unit band associated with the downlink control channel of the base unit. On the other hand, upon failing to receive downlink assignment control information transmitted in the base unit band or upon receiving the downlink assignment control information transmitted in the base unit band and detecting an error in the downlink data transmitted through the downlink data channel indicated by the downlink assignment control information, control section 209 transmits a bundled response signal using resources in the additional region of the uplink control channel reported to terminal 200 by base station 100 beforehand.

Thus, when ARQ is applied to communication using an uplink unit band and a plurality of downlink unit bands associated with the uplink unit band, it is possible to reduce overhead of an uplink control channel.

The above explanation presupposes that the basic region including basic PUCCH resources does not overlap with the additional region including additional PUCCH resources. However, the present invention is not limited to this, but the basic region may partially or totally overlap with the additional region. In short, the base station side needs only to perform control such that the basic PUCCH resources and additional PUCCH resources that should be recognized by a certain terminal in a certain subframe are different from each other. Base station 100 provides the basic region and additional region overlapping with each other in this way, and PUCCH overhead in the present system is thereby reduced to the equivalent of that of an LTE system.

Although the above explanation assumes that base station 100 reports PUCCH resources to be used as additional PUCCH resources to terminal 200 beforehand, even when base station 100 does not report the PUCCH resources beforehand, for example, information bits indicating the additional PUCCH resources may be included in all the downlink assignment control information transmitted in downlink unit bands other than the base unit band. In short, when succeeding in receiving even one piece of downlink assignment control information transmitted in downlink unit bands other than the base unit band, the terminal 200 side needs only to be able to recognize one additional PUCCH resource.

A case has been described above where a ZAC sequence is used for primary-spreading and an orthogonal code sequence is used for secondary-spreading. However, the present invention may also use non-ZAC sequences which are mutually separable by different cyclic shift indices for primary-spreading. For example, GCL (Generalized Chirp like) sequence, CAZAC (Constant Amplitude Zero Auto Correlation) sequence, ZC (Zadoff-Chu) sequence, M sequence, PN sequence such as orthogonal gold code sequence or a sequence randomly generated by a computer and having an abrupt auto-correlation characteristic on the time axis or the like may be used for primary-spreading. Furthermore, sequences orthogonal to each other or any sequences may be used as orthogonal code sequences for secondary-spreading as long as they are regarded as sequences substantially orthogonal to each other. For example, a Walsh sequence or Fourier sequence or the like may be used for secondary-spreading as an orthogonal code sequence. In the above descriptions, resources (e.g. PUCCH resources) of response signals are defined by a cyclic shift index of a ZAC sequence and a sequence number of an orthogonal cover index.

### Embodiment 2

A case has been described in Embodiment 1 where the number of downlink unit bands set in the terminal is 3. Embodiment 2 is different from Embodiment 1 in that the number of downlink unit bands set in a terminal is 2. This further reduces PUCCH overhead in Embodiment 2 compared to Embodiment 1.

This will be described more specifically below. Since the configurations of the base station and terminal according to Embodiment 2 are similar to those of Embodiment 1, the present embodiment will be described using FIG. 6 and FIG. 7. However, in base station 100 according to Embodiment 2, processing systems relating to PUCCH region 1 such as 116-1, 118-1 and 119-1 are not used.

In terminal 200 according to Embodiment 2, control section 209 transmits a response signal using constellation points according to a pattern of success/failure in reception of a plurality of downlink assignment control signals and a pattern of error detection results regarding a plurality of pieces of downlink data. Control section 209 uses additional PUCCH resources to transmit a response signal.

[Operations of Base Station 100 and Terminal 200]

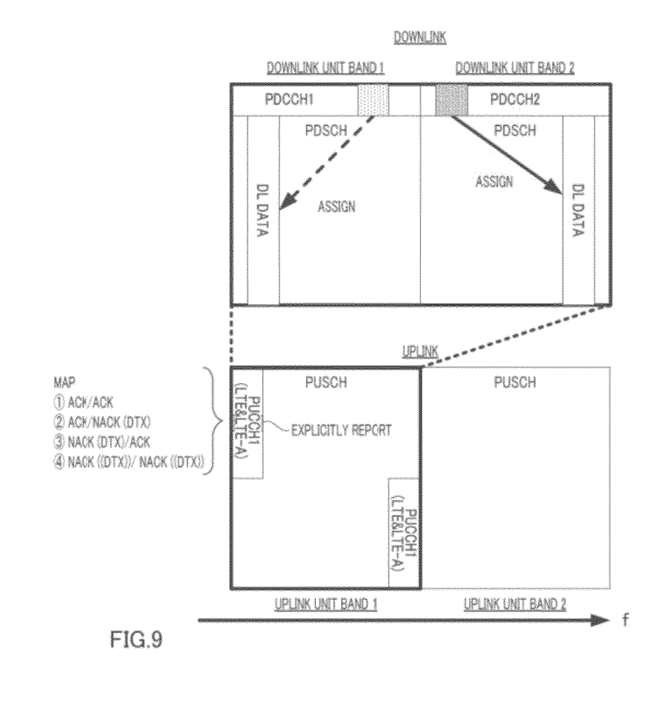

FIG. 9 is a diagram illustrating operations of base station 100 and terminal 200.

<Assignment of PUCCH Resources to Terminal 200 by Base Station 100>

Base station 100 reports additional PUCCH resources to be used to transmit a response signal to terminal 200. However, unlike Embodiment 1, terminal 200 does not use basic PUCCH resources defined in association with CCEs of the base unit band.

<Reception of Downlink Data by Terminal 200>

In terminal 200, broadcast signal receiving section 205 identifies a downlink unit band for transmitting a BCH to broadcast information on an uplink unit band making up a unit band group reported to terminal 200 as a base unit baud.

Furthermore, decision section 208 decides whether or not a downlink control channel of each downlink unit band includes downlink assignment control information directed to the terminal and outputs the downlink assignment control information directed to the terminal to extraction section 204.

Extraction section 204 extracts downlink data from the received signal based on the downlink assignment control information received from decision section 208.

Thus, terminal 200 can receive downlink data transmitted from base station 100.

Explaining more specifically with reference to FIG. 9, since a BCH for broadcasting information on uplink unit band 1 is transmitted in downlink unit band 1 first, downlink unit band 1 becomes the base unit band of terminal 200.

Furthermore, the downlink assignment control information transmitted in downlink unit band 1 includes information on resources used to transmit downlink data (DL data) transmitted in downlink unit band 1 and the downlink assignment control information transmitted in downlink unit band 2 includes information on resources used to transmit downlink data transmitted in downlink unit band 2.

Therefore, by receiving the downlink assignment control information transmitted in downlink unit bands 1 and 2, terminal 200 can receive downlink data in downlink unit bands 1 and 2. On the contrary, when the terminal cannot receive downlink assignment control information in a certain downlink unit baud, terminal 200 cannot receive downlink data in the downlink unit band.

Furthermore, terminal 200 can recognize the downlink unit band in which downlink assignment control information is transmitted through a DAI transmitted in each downlink unit band.

<Response by Terminal 200>

CRC section 212 performs error detection on downlink data corresponding to the downlink assignment control information that has been successfully received and outputs the error detection result to control section 209.

Control section 209 then performs transmission control over a response signal based on the error detection result received from CRC section 212 and the pattern of success/failure in reception of a plurality of downlink assignment control signals as follows.

That is, control section 209 transmits a response signal using additional PUCCH resources regardless of a pattern of success/failure in reception of a plurality of downlink assignment control signals and a pattern of error detection results regarding a plurality of pieces of downlink data. As described above; information of the additional PUCCH resources is shared between base station 100 and terminal 200 beforehand.

Furthermore, control section 209 transmits a response signal using constellation points according to a pattern of success/failure in reception of a plurality of downlink assignment control signals and a pattern of error detection results regarding a plurality of pieces of downlink data. That is, since there are two states; a case where the error detection result regarding downlink data about downlink unit band 1 and downlink unit band 2 shows “no error” and a “case of not succeeding in receiving downlink data,” there are four patterns of error detection results as a whole. Therefore, control section 209 switches between four constellation points (e.g. (I,Q)=(1,0), (−1,0), (0,j), (0,−j)) according to the pattern of error detection results.

However, in the “case of not succeeding in receiving downlink data,” the following two cases are also included here: A first case where the reception of downlink assignment control information corresponding to downlink data succeeds and an error is found in the downlink data decoding result, and a second case where the reception of the downlink assignment control signal itself fails in the downlink unit band in which the presence of downlink data is recognized by means of a DAI included in the downlink assignment control signal that has been successfully received. That is, although the terminal receives downlink assignment control signals in some downlink unit bands and recognizes by means of a DAI included therein that downlink data is assigned in other downlink unit bands, if the terminal fails to receive downlink assignment control signals in the other downlink unit bands and cannot therefore receive downlink data (that is, when DTX occurs in the other downlink unit bands), the terminal treats this case the same as the case with “error present” in the downlink unit band in which the terminal fails to receive the downlink assignment control signal.

As described so far, the present embodiment need not use basic PUCCH resources, and can thereby further reduce PUCCH overhead compared to Embodiment 1.

### Other Embodiments

(1) A case has been described in the above-described embodiments where only one uplink unit band is included in a unit band group in asymmetric carrier aggregation configured for the terminal, and the basic PUCCH resources and the additional PUCCH resources are included in the same uplink unit band. However, the present invention is not limited to this, but a plurality of uplink unit bands may be included in the unit baud group and the basic PUCCH resources and the additional PUCCH resources may be defined in different uplink unit bands.

(2) Only asymmetric carrier aggregation has been described in the above-described embodiments. However, the present invention is not limited to this, but the present invention is also applicable to a case where symmetric carrier aggregation is set with respect to data transmission. In short, the present invention is applicable to any case where a plurality of PUCCH regions are defined in uplink unit bands included in the unit band group of the terminal and a PUCCH region including PUCCH resources to be used is determined according to the situation of success/failure in reception of downlink data.

(3) Furthermore, the ZAC sequence in the above-described embodiments may also be referred to as “base sequence” in the sense that it is a sequence that serves as the basis for applying cyclic shift processing.

Furthermore, the Walsh sequence may also be referred to as “Walsh code sequence.”

(4) Furthermore, a case has been described in the above-described embodiments where secondary-spreading is performed after primary-spreading and IFFT transform as the order of processing on the terminal side. However, the order of processing is not limited to this. That is, since both primary-spreading and secondary-spreading are multiplication processing, an equivalent result may be obtained regardless of the location of secondary-spreading processing as long as IFFT processing follows primary-spreading processing.

(5) Furthermore, since the spreading section according to the above-described embodiments performs processing of multiplying a certain signal by a sequence, the spreading section may also be called a “multiplication section.”

(6) Moreover, although cases have been described with the embodiments above where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-146593, filed on Jun. 19, 2009, including the specification, drawings and abstract is incorporated herein by reference in its entirety.

### INDUSTRIAL APPLICABILITY

The terminal apparatus and retransmission control method according to the present invention can reduce overhead of an uplink control channel and are useful for when ARQ is applied to communication using an uplink unit band and a plurality of downlink unit bands associated with the uplink unit band.

### REFERENCE SIGNS LIST

100 base station
101 control section
102 control information generation section
103 coding section
104, 108, 214 modulation section
105 broadcast signal generation section
106 coding section
107 data transmission control section
109 mapping section
110, 217 IFFT section
111, 218 CP adding section
112, 219 radio transmitting section
113, 201 radio receiving section
114, 202 CP removing section
115 PUCCH extraction section
116 despreading section
117 sequence control section
118 correlation processing section
119, 208 decision section
120 retransmission control signal generation section
200 terminal
203 FFT section
204 extraction section
205 broadcast signal receiving section
206, 210 demodulation section
207, 211 decoding section
209 control section
212 CRC section
213 response signal generation section
215 primary-spreading section
216 secondary-spreading section

1. A terminal apparatus that communicates with a base station using a unit band group made up of a plurality of downlink unit bands and an uplink unit band and transmits one bundled response signal through an uplink control channel of the uplink unit band based on error detection results of a plurality of pieces of downlink data arranged in the plurality of downlink unit bands, comprising:
a control information receiving section that receives downlink assignment control information transmitted through downlink control channels of the plurality of downlink unit bands;
a downlink data receiving section that receives downlink data transmitted through a downlink data channel indicated by the downlink assignment control information;
an error detection section that detects a reception error of the received downlink data; and
a response control section that transmits the bundled response signal using one of a basic region and an additional region of the uplink control channel based on the error detection result obtained in the error detection section and success/failure in reception of the downlink assignment control information, wherein:
when the number of downlink unit bands included in the unit band group is 3, if the response control section receives downlink assignment control information transmitted in a base unit band which is a downlink unit band for transmitting a broadcast channel signal including information on the uplink unit band and detects no error in the downlink data transmitted through the downlink data channel indicated by the downlink assignment control information, the response control section transmits the bundled response signal using resources in the basic region associated with the downlink control channel of the base unit band, and,
when failing to receive downlink assignment control information transmitted in the base unit band or when receiving downlink assignment control information transmitted in the base unit band and detecting an error in the downlink data transmitted through the downlink data channel indicated by the downlink assignment control information, the response control section transmits the bundled response signal using resources in the additional region.

2. A retransmission control method comprising:
a control information receiving step of receiving downlink assignment control information transmitted through downlink control channels of a plurality of downlink unit bands included in a unit band group;
a downlink data receiving step of receiving downlink data transmitted through a downlink data channel indicated by the downlink assignment control information;
an error detection step of detecting a reception error of the received downlink data; and
a response control step of transmitting one bundled response signal based on error detection results of a plurality of pieces of downlink data arranged in the plurality of downlink unit bands using one of a basic region and an additional region of an uplink control channel in an uplink unit band included in the unit band group based on the error detection results obtained in the error detection section and success/failure in reception of the downlink assignment control information, wherein:
in the response control step, when the number of downlink unit bands included in the unit band group is 3, downlink assignment control information transmitted in a base unit band which is a downlink unit band for transmitting a broadcast channel signal including information on the uplink unit band is received and when no error is detected in the downlink data transmitted in the downlink data channel indicated by the downlink assignment control information, the bundled response signal is transmitted using resources in the basic region associated with the downlink control channel of the base unit band, and
when reception of the downlink assignment control information transmitted in the base unit band fails or the downlink assignment control information transmitted in the base unit band is received and an error is detected in the downlink data transmitted through the downlink data channel indicated by the downlink assignment control information, the bundled response signal is transmitted using resources in the additional region.
